(19) United States
(12) Patent Application Publication
(10) Pub. No.: US 2025/0154035 A1
(43) Pub. Date: May 15, 2025

(54) WASTE WATER DISPOSAL METHOD

(71) Applicant: Independence Oilfield Chemicals LLC, The Woodlands, TX (US)

(72) Inventors: Ashley Gothard, Fischer, TX (US); Butch Gothard, Canyon Lake, TX (US)

(21) Appl. No.: 18/947,640

(22) Filed: Nov. 14, 2024

Related U.S. Application Data
(60) Provisional application No. 63/599,349, filed on Nov. 15, 2023.

(51) Int. Cl. C02F 1/68; C02F 5/08; C02F 103/10

(52) U.S. Cl. CPC C02F 1/68; C02F 5/08; C02F 2103/10; C02F 2303/08; C02F 2305/04

(57) ABSTRACT

Novel additive compositions and methods of improving injectivity of an aqueous composition into a disposal reservoir during a water disposal operation.

### FIELD

The invention relates to a method of improving injectivity of an aqueous composition into a disposal reservoir during a water disposal operation using one or more biosurfactants, and to the use of one or more biosurfactants to improve injectivity of an aqueous composition into a disposal reservoir during a water disposal operation. The invention also relates to an additive composition comprising one or more biosurfactants.

### BACKGROUND

Many industrial processes produce large volumes of aqueous waste. Notably, during oil and gas operations, aqueous waste is produced when water trapped in geologic formations is liberated alongside the oil and gas that is pumped to the surface or when an aqueous fluid is used in a drilling or stimulation operation. For example, flow back water is produced during oil and gas fracturing processes and produced water (also known as formation water) is generated during crude oil production. Flow back water is a complex aqueous composition comprising water, hydrocarbons and typically also chemical additives (for example chemicals used in hydraulic fracturing or drilling) and metal ions, and is typically artificially created by operators during stimulation operations. Produced water is a naturally occurring aqueous composition that exists in underground reservoirs and comprises water, hydrocarbons and a high metal salts content, often defined as total dissolved solids (TDS).

Typically aqueous waste, such as flow back water and produced water, must be treated to remove undesirable components. Such treatments typically involve physical, chemical and biological processes. However, currently used treatment processes generally produce aqueous compositions in which certain undesirable components remain, such that the compositions cannot be re-used. Therefore, the treated aqueous waste compositions are disposed of by injection into a disposal reservoir. As large volumes of treated aqueous waste compositions are produced annually, it is desirable to improve processes for their disposal.

Aqueous compositions comprising undesirable components may also be produced by processes such as industrial manufacturing processes and processes to dispose of municipal aqueous waste and sewage. Thus, there is a need for alternative and/or improved methods for disposing of aqueous compositions, which processes may provide improvements in terms of the rate and/or ease of disposal, and which may provide improved efficiency and/or reduced costs.

It is thus an object of the present invention to provide methods for disposing of aqueous compositions, for example by providing methods for injecting aqueous compositions into a disposal reservoir, which methods may be more effective than, or which may provide an alternative to, existing methods for disposing of aqueous compositions.

### SUMMARY

According to a first aspect of the invention, there is provided a method of improving injectivity of an aqueous composition into a disposal reservoir during a water disposal operation, the method comprising admixing one or more biosurfactants with the aqueous composition to provide an aqueous admixture and injecting the aqueous admixture into the disposal reservoir.

According to a second aspect of the invention, there is provided the use of one or more biosurfactants to improve injectivity of an aqueous composition into a disposal reservoir during a water disposal operation.

According to a third aspect of the invention, there is provided an additive composition comprising one or more biosurfactants and one or more corrosion inhibitors and/or one or more scale inhibitors.

According to a fourth aspect of the invention, there is provided an aqueous admixture comprising an additive composition according to the third aspect and an aqueous composition.

According to a fifth aspect of the invention, there is provided a method of making an aqueous admixture according to the fourth aspect, the method comprising admixing an additive composition according to the third aspect and an aqueous composition.

According to a sixth aspect of the invention, there is provided an assembly positioned adjacent to a disposal reservoir, said assembly being arranged to deliver an aqueous composition and an additive composition (for example as an admixture, such as an aqueous admixture) into the disposal reservoir, said assembly comprising:
(i) a first storage receptacle containing an aqueous composition;
(ii) a second storage receptacle containing an additive composition according to the third aspect;
(iii) a conduit for delivering the aqueous composition and the additive composition as an admixture to the disposal reservoir; and
(iv) a pump and optional flow meter for dosing the admixture via said conduit into the disposal reservoir.

### DETAILED DESCRIPTION

Unless otherwise stated, the following terms used in the specification and claims have the meanings set out below.

The terms “alkyl” and “alkylene” include both straight and branched chain alkyl and alkylene groups respectively unless otherwise stated.

The term “hydrocarbyl” is used in its ordinary sense, which is well-known to those skilled in the art. Specifically, it refers to a group having a carbon atom directly attached to the remainder of the molecule and having predominantly hydrocarbon character.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.70 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

In this specification any reference to ppm is to parts per million by volume.

According to a first aspect of the invention, there is provided a method of improving injectivity of an aqueous composition into a disposal reservoir during a water disposal operation, the method comprising admixing one or more biosurfactants with the aqueous composition to provide an aqueous admixture and injecting the aqueous admixture into the disposal reservoir.

According to a second aspect of the invention, there is provided the use of one or more biosurfactants to improve injectivity of an aqueous composition into a disposal reservoir during a water disposal operation.

By improving (or to improve) injectivity of an aqueous composition, we mean to improve a parameter associated with how the aqueous composition (or an aqueous admixture comprising the aqueous composition) is injected into a disposal reservoir compared to a water disposal operation without the use of one or more biosurfactants. References herein to improving (or to improve) injectivity of an aqueous composition mean an improvement whilst maintaining the same injection parameters. According to the method of the invention, one or more biosurfactants are admixed with (or added to) the aqueous composition to form an aqueous admixture, which aqueous admixture provides improved injectivity into a disposal reservoir. In other words, the aqueous composition is injected into a disposal reservoir as a component of an aqueous admixture.

For example, the injectivity of the aqueous composition (or of the aqueous admixture comprising the aqueous composition) may be improved by increasing the rate and/or decreasing the pressure at which the aqueous composition (or aqueous admixture) is injected into a disposal reservoir compared to a water disposal operation without the use of a biosurfactant. The injectivity of the aqueous composition (or aqueous admixture) may be improved by increasing the rate at which the aqueous composition (or aqueous admixture) is injected into a disposal reservoir without increasing the pressure compared to a water disposal operation without the use of one or more biosurfactants. The injectivity of the aqueous composition (or aqueous admixture) may be improved by decreasing the pressure at which the aqueous composition (or aqueous admixture) is injected into a disposal reservoir whilst reducing the friction within a specified time period compared to a water disposal operation without the use of one or more biosurfactants. References to improvements relating to the aqueous composition may refer to the aqueous composition as a component of the aqueous admixture, i.e. which aqueous admixture may comprise one or more biosurfactants as disclosed herein and/or an additive composition as disclosed herein.

Improvements in injectivity may be demonstrated by an improvement in the throughput in the pressurised Millipore test as described in Example 1 herein.

Increasing the rate at which the aqueous composition (or aqueous admixture) is injected into a disposal reservoir is advantageous as it reduces the time taken for a volume of the aqueous composition (for example as a component of the aqueous admixture) to be disposed of, which reduces costs, reduces the power usage and increases the bbl/psi value. Decreasing the pressure at which the aqueous composition (or aqueous admixture) is injected into a disposal reservoir compared to a water disposal operation without the use of one or more biosurfactants is advantageous as it makes the disposal easier and more efficient, and also improves operator safety. Such improvements may also enable the use of a lower dose of additive compared to alternative additives.

In the method or use according to the invention, the injectivity of the aqueous composition (for example as a component of an aqueous admixture) may be improved by increasing the rate and/or decreasing the pressure at which the aqueous composition or aqueous admixture is injected into the disposal reservoir compared to a water disposal operation without the use of one or more biosurfactants.

The aqueous composition is to be subject to a water disposal operation. In other words, the aqueous composition requires disposal. The method and use of the invention may be conducted with any suitable aqueous composition which requires disposal. For example, the aqueous composition may be a waste composition, for example produced during oil and gas operations or during manufacturing processes (such as chemical manufacturing processes). The aqueous composition may comprise flow back water or produced water.

The aqueous composition comprises water and additional components, which additional components may be selected from one or more of volatile hydrocarbons, non-volatile hydrocarbons, hydraulic fracturing fluids, mud, crude oil, drilling cuttings, chemical additives and metal ions/salts (including mixtures thereof).

The water comprised in the aqueous composition may be or may derive from brine, produced water, flowback water, fracturing water and/or fresh water. The aqueous composition may comprise water from a mixture of sources, such as a mixture of fresh water and water derived from brine, produced water, flowback water and/or fracturing water.

The water comprised in the aqueous composition may comprise iron in an amount of up to 50 ppm. The iron content may be measured using a standard technique known in the art, such as inductively coupled plasma mass spectrometry (ICP-MS).

The water comprised in the aqueous composition may have a Total Dissolved Solids (TDS) value of at least 5,000 ppm, for example at least 10,000 ppm, at least 15,000 ppm or at least 20,000 ppm. The TDS may be analysed by ICP Ion breakdown, which would be well known to persons skilled in the art.

By a disposal reservoir, we mean any entity in which an aqueous composition or aqueous admixture may be stored (i.e. for disposal). Typically the disposal reservoir may store large or industrial volumes of an aqueous composition or aqueous admixture. Suitable disposal reservoirs may be surface or subsurface reservoirs. Examples of suitable surface disposal reservoirs include tanks and barrels. Examples of suitable subsurface disposal reservoirs include disposal wells (especially depleted oil and gas wells that the aqueous composition, for example as a component of an aqueous admixture, can be safely injected into), underground caverns and other underground spaces.

Suitably, the disposal reservoir may be a subsurface reservoir, such as a disposal well.

By a water disposal operation we mean a process by which water in the form of an aqueous composition (for example as a component of an aqueous admixture) is disposed of, for example by injection into a disposal reservoir. The aqueous composition (or aqueous admixture) may be injected into the disposal reservoir at any suitable pressure, such as at a pumping pressure of from 30 to 3000 psi. Typically, the water disposal operation includes a water treatment step, to remove or reduce undesirable components of the composition, prior to disposal. Such treatment steps would be well known to persons skilled in the art and may, for example, include filtration.

In order to provide the method of the invention, the aqueous composition is admixed with the one or more biosurfactants (which biosurfactants may be comprised in an additive composition, such as an additive composition according to the third aspect) to provide an aqueous admixture. The aqueous composition may be admixed with the one or more biosurfactants (which biosurfactants may be comprised in an additive composition, such as an additive composition according to the third aspect) to provide an aqueous admixture in order to provide the use of the invention.

Thus, by aqueous admixture we mean an admixture (or composition) comprising the aqueous composition and the one or more biosurfactants, and optional additional components (for example which may be comprised in an additive composition, such as an additive composition according to the third aspect of the invention). Thus, references herein to injecting the aqueous composition into a disposal reservoir, typically mean injecting the aqueous composition as a component of the aforementioned aqueous admixture.

According to a fourth aspect of the invention, there is provided an aqueous admixture comprising an additive composition according to the third aspect and an aqueous composition.

According to a fifth aspect of the invention, there is provided a method of making an aqueous admixture according to the fourth aspect, the method comprising admixing an additive composition according to the third aspect and an aqueous composition.

The aqueous composition or aqueous admixture may be injected into a disposal reservoir using any suitable method, which methods would be well known to persons skilled in the art.

According to a sixth aspect of the invention, there is provided an assembly positioned adjacent to a disposal reservoir, said assembly being arranged to deliver an aqueous composition and an additive composition (for example as an admixture) into the disposal reservoir, said assembly comprising:
(i) a first storage receptacle containing an aqueous composition;
(ii) a second storage receptacle containing an additive composition according to the third aspect;
(iii) a conduit for delivering the aqueous composition and the additive composition as an admixture to the disposal reservoir; and
(iv) a pump and optional flow meter for dosing the admixture via said conduit into the disposal reservoir.

Suitably the conduit is in communication with the first and second storage receptacles and with the disposal reservoir. The aqueous admixture may be formed at any suitable stage, such as in the conduit prior to delivery to the disposal reservoir.

The method of the first aspect of the invention comprises admixing one or more biosurfactants with an aqueous composition. The use of the second aspect of the invention refers to the use of one or more biosurfactants to improve injectivity of an aqueous composition. Thus, the method and use of the invention make use of one or more biosurfactants.

References herein to one or more biosurfactants includes mixtures of different biosurfactants when more than one biosurfactant is used.

By the term biosurfactant we mean a surfactant that is produced by microorganisms, for example which may be a product of a fermentation process. Typically, a biosurfactant is generated as a metabolic product during bacterial, fungal or algal fermentation, and the metabolic product may be further derivatised. Thus, references herein to a biosurfactant refer to biosurfactants that are direct metabolic products of bacterial, fungal or algal fermentation, as well as derivatives of the direct metabolic products. Similarly, references herein to a specific biosurfactant also refer to derivatives of that biosurfactant unless otherwise stated.

The use of biosurfactants in the method and use of the invention is advantageous, because biosurfactants are natural products, are generated in a sustainable way, are environmentally benign and typically have low toxicity.

Biosurfactants are typically classified in four categories as polymeric biosurfactants, lipopeptides (or also called proteo-lipids), phospholipids and glycolipids. The one or more biosurfactants may be a complex mixture of biosurfactants.

Biosurfactants may comprise one or more fatty acid and/or fatty alcohol residues. Suitably biosurfactants useful in the invention comprise one or more fatty acid residues.

The one or more fatty acid and/or fatty alcohol residues that may be present in the biosurfactants may be the same or different and may be derived from any suitable fatty acid and/or fatty alcohol, preferably from a naturally occurring fatty acid and/or fatty alcohol. Fatty acid residues are mostly derived from natural plant oils in the form of triglycerides. For example, biocatalysts may hydrolyse lipid esters in natural plant oils forming fatty acids and glycerol. Suitably, the fatty acid and/or fatty alcohol residues may comprise a branched or unbranched, saturated or unsaturated, hydrocarbyl group.

The fatty acid and/or fatty alcohol residues that may be present in the biosurfactants may comprise from 4 to 50 carbon atoms, for example from 6 to 30 carbon atoms, preferably from 8 to 24 carbon atoms, more preferably from 12 to 22, or from 14 to 20 or from 16 to 18 carbon atoms. Preferred biosurfactants may therefore comprise residues of fatty acids derived from oleic acid, hydroxy substituted oleic acid (such as ricinoleic acid), palmitic acid and vegetable oils (such as sunflower, corn, soya, safflower oil and rapeseed oil).

Any suitable biosurfactant(s) may be used. For example, the one or more biosurfactants may be independently selected from a glycolipid, a lipopeptide, a phospholipid and a polymeric biosurfactant (and mixtures thereof).

The one or more biosurfactants may each have any suitable molecular weight, such as a molecular weight of from 200 to 3000 g mol⁻¹, for example from 250 to 2000 g mol⁻¹, such as from 500 to 1500 g mol⁻¹.

The one or more biosurfactants may be glycolipids. Glycolipids comprise one or more carbohydrate residues in addition to the one or more fatty acid and/or fatty alcohol residues. The carbohydrate and fatty acid/fatty alcohol residues are joined either by means of a linker group or a direct bond, for example via an ester, amide or glycosidic bond.

Suitable glycolipids may comprise one or more carbohydrate residues selected from rhamnose, trehalose, sophorose, mannose, galactose, glucose, cellobiose, glucosamine, sulfoquinovose, fructose, xylose, sucrose, lactose, maltose, sorbitol, erythritol and/or mannitol residues. For example, the one or more carbohydrate residues may be selected from rhamnose, trehalose, sophorose, mannose, erythritol, galactose, cellobiose and/or glucose residues. Preferably, the one or more carbohydrate residues may be selected from rhamnose, trehalose, sophorose, mannose and/or erythritol residues. More preferably, the one or more carbohydrate residues may be selected from sophorose and/or rhamnose residues. Most preferably, the one or more carbohydrate residues may be sophorose residues.

Suitable glycolipids may be selected from one or more of a rhamnolipid, a trehalolipid, a sophorolipid, a mannosylerythritol lipid, a glycolipid produced by Meyerozama guilliermondii, Saccharomyces cerevisiae, Candida utilis, Candida bombicola and/or Marinobacter hydrocarbonoclasticus.

For example, suitable glycolipids may be selected from one or more of a rhamnolipid, a trehalolipid, a sophorolipid and/or a mannosylerythritol lipid. Suitably, the one or more biosurfactants are sophorolipids.

For example, the one or more biosurfactants may be independently selected from a rhamnolipid, a trehalolipid, a sophorolipid and a mannosylerythritol lipid. The one or more biosurfactants may be selected from one or more rhamnolipids and/or one or more sophorolipids. Suitably, the one or more biosurfactants are sophorolipids.

Rhamnolipids comprise a rhamnose residue. Examples of suitable rhamnolipids may include those produced by species of Pseudomonas, Lysinibacillus and/or Serratia, for example those produced by Pseudomonas aeruginosa, Pseudomonas cepacia, Lysinibacillus sphaericus and/or Serratia rubidaea.

Trehalolipids comprise a trehalose residue. Examples of suitable trehalolipids may include those produced by species of Nocardia, Rhodococcus, Starmerella, Arthrobacter, Corynebacterium and/or Candida, for example those produced by Rhodococcus erythropolis, Nocardia farcinica and/or Candida bombicola (also known as Starmerella bombicola).

Sophorolipids comprise a sophorose residue. Examples of suitable sophorolipids may include those produced by species of Candida, Starmerella and/or Cutaneotrichosporon, for example those produced by Candida sphaerica, Starmerella bombicola and/or Cutaneotrichosporon mucoides. Suitable sophorolipids may exist in the “lactonic” form wherein a fatty acid residue is bonded separately to each ring of the sophorose residue to form a lactonic macrocycle. When the fatty acid residue is not bonded to a sophorose residue this may be known as the “acidic” form. Suitable sophorolipids may have a molar ratio of acidic to lactonic form in the range 99:1 to 1:99, for example in the range 50:50 to 60:40. Suitable sophorolipids may have a molar ratio of acidic to lactonic form of 70:30. Suitably, greater than 60%, for example greater than 70%, preferably greater than 80%, more preferably greater than 90%, of the sophorolipids may comprise an unsaturated fatty acid and/or fatty alcohol residue.

Mannosylerythritol lipids comprise a mannose residue and an erythritol residue, preferably joined by an ether bond. Examples of suitable mannosylerythritol lipids may include those produced by species of Pseudozyma and/or Ustilago, for example Pseudozyma aphidis or Pseudozyma antarctica.

The one or more biosurfactants may be lipopeptides. Lipopeptides comprise one or more peptide residues in addition to the one or more fatty acid and/or fatty alcohol residues. The one or more peptide residues may be cyclic peptide residues. Suitable lipopeptides may include surfactins, lichenysins, and/or those produced by Pseudomonas azotoformans, Bacillus velezensis, Bacillus pseudomycoides, Virgibacillus salaries, Bacillus cereus, Bacillus pumilius or Halomonas species.

Surfactins may be produced by Bacillus species, such as B. subtillis or B. nealsonii.

Lichenysins may be produced by Bacillus species, such as B. licheniformis.

For example, the one or more biosurfactants may be independently selected from surfactin and lichenysin.

The one or more biosurfactants may be phospholipids. Phospholipids comprise one or more phosphate groups in addition to the one or more fatty acid and/or fatty alcohol residues.

Phospholipids may further comprise a linker group joining the one or more phosphate groups and the one or more fatty acid and/or fatty alcohol residues. Suitable linker groups may for example comprises an alcohol residue such as glycerol or sphingosine. Suitable phospholipids include those produced by species of Acinetobacter and/or Acidithiobacillus, for example Acidithiobacillus thiooxidans.

The one or more biosurfactants may be polymeric biosurfactants. Polymeric biosurfactants are biopolymers (e.g. polysaccharides, polypeptides) comprising fatty acid and/or fatty alcohol residues.

Suitable polymeric biosurfactants include cellulose, guar, diutan, starch, chitin, chitosan, glycogen, xanthan, dextran, dextrin, welan, gellan, pullulan, pectin, scleroglucan, schizophyllan, levan, locust bean gum, peptidoglycan, tara, konjak, tamarind, starch, karaya, tragacanth, carrageenan, glycan, succinoglycan, glucan, scleroglucan, maltodextrin, cyclodextrin, inulin, alginates, amylose, amylopectin, liposan, rufisan, emulsan, lipomanan and/or alasan. Polymeric biosurfactants may include those produced by species of Candida and/or Acinetobacter, for example Candida lipolytica, Acinetobacter lwoffi and/or Acinetobacter radioresistens.

For example, the one or more biosurfactants may be independently selected from liposan, rufisan, emulsan and alasan.

For example, the one or more biosurfactants may be independently selected from a rhamnolipid, a trehalolipid, a sophorolipid, a mannosylerythritol lipid, surfactin, lichenysin, liposan, rufisan, emulsan and alasan.

Biosurfactants useful in the invention may be those produced by species of Pseudomonas, Lysinibacillus, Serratia, Nocardia, Rhodococcus, Candida, Starmerella, Cutaneotrichosporon, Pseudozyma, Meyerozyma, Saccharomyces, Marinobacter, Bacillus, Lactobacillus Virgibacillus, Halomonas, Thiobacillus, Acidithiobacillus, Klebsiella, Alcanivorax, Arthrobacter, Rhodotorula, Tsukamurella, Ustilago, Sphingomonas, Mycobacterium, Streptomyces, Gluconobacter, Aspergillus and/or Acinetobacter.

The biosurfactants that are produced by a specific micro-organism may vary depending on the feedstock used and other variables in the growth conditions (e.g. temperature, pH, agitation and dissolved oxygen). Preferably, feedstocks comprise carbohydrates and/or lipids. Preferred lipid feedstocks are in the form of triglycerides. The feedstocks may comprise agricultural and/or industrial waste, for example vegetable oils, animal or vegetable fats, cooking oil waste, whey, glycerol, and/or combinations thereof. Biosurfactants suitable for the invention are preferably produced by micro-organisms from feedstock comprising carbohydrate and one or more lipids. More preferably, they are produced from feedstock comprising carbohydrate and one or more of vegetable oils (for example rapeseed, palm, sunflower, corn, soya and/or safflower oils), animal fats and vegetable fats.

Biosurfactants useful in the invention may be recovered from the fermentation broth before use by known recovery methods. For example, the biosurfactants may be recovered by precipitation, filtration (including ultrafiltration), adsorption to solid supports, centrifugation, chromatography (e.g. ion-exchange chromatography), foam fractionation, liquid-liquid extraction, and/or gravity separation (decanting).

Biosurfactants useful in the invention may be used as crude extracts, or they may undergo further purification and/or derivatisation before use.

Where biosurfactants are further purified, this may involve one or more purification techniques available to the skilled person, for example chromatographic techniques, ultrafiltration or washing with a suitable solvent (which solvent may be polar or non-polar).

Where biosurfactants are further derivatised, this may comprise derivatisation of the fatty acid and/or fatty alcohol residues. Where the fatty acid or fatty alcohol residue has an unsaturated alkyl group, suitable methods for derivatisation of the fatty acid or fatty alcohol residue include mild reductive, strong reductive or oxidative ozonolysis with sodium periodate (resulting in a dialdehyde, diol or diacid respectively); dihydroxylation, for example with OsO₄; epoxidation, for example with m-chloroperoxybenzoic acid; reduction, for example with H₂ on a Pd/C catalyst; ring opening metathesis; treatment with HBr; or mono-hydroxylation, for example by hydroboration with an oxidative work-up.

Where the biosurfactant is a glycolipid, the carbohydrate may be derivatised at the alcohol groups by esterification (e.g. with an anhydride), carboxymethylation (e.g. with an α-chloro acid), oxidation (to e.g. aldehyde or carboxylic acid), reaction with a non-ionic epoxide (e.g. ethylene oxide, propylene oxide), reaction with a cationic epoxide (e.g. glycidyltrimethyl ammonium chloride). The carbohydrate may be further derivatised by oxidative ring opening (e.g. with a periodate) resulting in a dialdehyde.

Derivatives of biosurfactants comprising aldehyde groups may be further derivatised, for example to alcohols, carboxylic acids, esters, amides, imines and/or amines. Derivatives of biosurfactants comprising carboxylic acid groups may be further derivatised, for example to esters and/or amides. Derivatives of biosurfactants comprising 1,2-diol groups may be further derivatised, for example by C—C bond cleavage with periodate or peroxide, or reaction with an aldehyde.

The method of the first aspect and the use of the second aspect of the invention may improve injectivity using one or more additional additives in addition to the one or more biosurfactants. The one or more additional additives may, for example, comprise one or more corrosion inhibitors and/or one or more scale inhibitors, and/or one or more further optional additives including for example one or more oxidising agents.

When present, the one or more additional additives may be admixed with the one or more biosurfactants and the aqueous composition to form an aqueous admixture, which admixture is injected into the disposal reservoir.

Thus, the first aspect of the invention may provide a method of improving injectivity of an aqueous composition into a disposal reservoir during a water disposal operation, the method comprising admixing one or more biosurfactants and one or more additional additives (such as one or more corrosion inhibitors and/or one or more scale inhibitors, and/or one or more further optional additives including for example one or more oxidising agents) with the aqueous composition to provide an aqueous admixture and injecting the aqueous admixture into the disposal reservoir.

The second aspect of the invention may provide the use of one or more biosurfactants and one or more additional additives (such as one or more corrosion inhibitors and/or one or more scale inhibitors, and/or one or more further optional additives including for example one or more oxidising agents) to improve injectivity of an aqueous composition into a disposal reservoir during a water disposal operation.

When the method or use of the invention utilises one or more additional additives (in addition to the one or more biosurfactants), one or more of the additional additives may be admixed with the aqueous composition (i.e. to form an aqueous admixture) separately to the one or more biosurfactants. In such methods, the one or more biosurfactants and the one or more additional additives may be admixed with the aqueous composition concurrently or sequentially in any suitable order.

For example, the method of the invention may comprise a first step of admixing one or more biosurfactants and optionally one or more additional additives with the aqueous composition to provide a first aqueous admixture and a second step of admixing one or more additional additives with the first aqueous admixture to form a second aqueous admixture, which second aqueous admixture is injected into the disposal reservoir. For example, the method of the invention may comprise a first step of admixing one or more additional additives with the aqueous composition to provide a first aqueous admixture and a second step of admixing one or more biosurfactants and optionally one or more additional additives with the first aqueous admixture to form a second aqueous admixture, which second aqueous admixture is injected into the disposal reservoir.

The method or use of the invention may include a first or second step as discussed above in which the one or more additional additives may comprise one or more oxidising agents. For example, the method of the invention may comprise a first step of admixing one or more oxidising agents with the aqueous composition to provide a first aqueous admixture and a second step of admixing one or more biosurfactants and optionally one or more additional additives with the first aqueous admixture to form a second aqueous admixture, which second aqueous admixture is injected into the disposal reservoir.

Any suitable oxidising agents may be used, including for example peracetic acid and/or hydrogen peroxide. The oxidising agents may be comprised in an oxidising composition, as would be appreciated by a person skilled in the art. When present, the one or more oxidising agents may be added to the aqueous composition in any suitable amount. For example, the one or more oxidising agents may be admixed with the aqueous composition at a concentration of from 5 to 1000 ppm, such as from 25 to 500 ppm or from 50 to 300 ppm or from 50 to 200 ppm, such as from 50 to 150 ppm.

The one or more biosurfactants may be comprised in an additive composition, such as an additive composition according to the third aspect of the invention. In other words, the method or use of the invention may utilise an additive composition that comprises one or more biosurfactants.

The additive composition may comprise the one or more biosurfactants in any suitable amount. For example, the additive composition may comprise at least 5 wt %, such as at least 7 wt % or at least 8 wt %, of the one or more biosurfactants, and/or the additive composition may comprise up to 30 wt %, such as up to 25 wt %, up to 20 wt % or up to 10 wt % of the one or more biosurfactants. The additive composition may, for example, comprise from 5 to 30 wt %, for example from 5 to 25 wt %, or from 5 to 22 wt % or from 5 to 10 wt %, of the one or more biosurfactants.

The additive composition (with which the method or use of the invention may be utilised) may further comprise one or more corrosion inhibitors and/or one or more scale inhibitors. The inclusion of one or more corrosion inhibitors and/or one or more scale inhibitors in the additive composition is advantageous because it provides an additional effect of reducing corrosion and/or scale in the equipment used for storage and/or injecting the aqueous admixture into the disposal reservoir.

The additive composition may comprise any combination of the one or more corrosion inhibitors and/or one or more scale inhibitors. For example, the additive composition may comprise one or more corrosion inhibitors and no scale inhibitors, or the additive composition may comprise one or more scale inhibitors and no corrosion inhibitors, or the additive composition may comprise one or more corrosion inhibitors and one or more scale inhibitors.

The additive composition may comprise one or more of each of the corrosion inhibitors and scale inhibitors and may comprise mixtures of different corrosion inhibitors and scale inhibitors when more than one such inhibitor compound is used. For example, when reference is made to the additive composition comprising one or more corrosion inhibitors this includes mixtures of different corrosion inhibitors when more than one corrosion inhibitor is comprised in the composition (with the same applying to the scale inhibitors).

Examples of suitable corrosion inhibitors include quaternary ammonium salts such as N—C₁₋₁₈ alkyl, N,N-dimethyl benzyl ammonium halides, especially benzenemethanaminium, N-(3-aminopropyl)-N,N-dimethyl-, N-coco acyl derivatives (cas no. 61789-70-6) sold as Marcor 900 and N-coco, N,N-dimethyl benzyl ammonium chloride (ABDAC corrosion inhibitor); imidazolines formed by the reaction product of a fatty acid and polyamine and quaternised derivatives thereof, especially tall oil fatty acid reacted with aminoethylethanolamine (QC 112); alkoxylated polyamines, including ethoxylated N-tallow amines for example N-(tallow alkyl)trimethylenediamine reacted with 1 to 25, especially 10 to 25, moles of ethylene oxide; and mixtures of corrosion inhibitors such as OGI-7566 (commercially available from Speciality Intermediates).

The additive composition may comprise the one or more corrosion inhibitors (when present) in any suitable amount. For example, the additive composition may comprise at least 5 wt %, such as at least 10 wt %, of the one or more corrosion inhibitors, and/or the additive composition may comprise up to 30 wt %, such as up to 26 wt % of the one or more corrosion inhibitors. The additive composition may, for example, comprise from 5 to 30 wt %, such as from 10 to 30 wt % of the one or more corrosion inhibitors.

Examples of suitable scale inhibitors include phosphonate-based and acrylate-based scale inhibitors.

Suitable scale inhibitors may include a moiety (X) as follows:

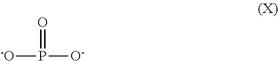

For example, suitable scale inhibitors may include multiple (for example at least 2, 3, 4 or 5) moieties of formula (X) per molecule of scale inhibitor. Suitable scale inhibitors are preferably an organic molecule which includes said one or more moieties (X). For example, suitable scale inhibitors may include one or more saturated —CH₂-containing chains, for example of formula —(CH₂)n- wherein n is at least 2 and may be less than 10.

Suitable scale inhibitor may include one or more (preferably at least 2 or at least 3) amino moieties, for example tertiary amino moieties.

Suitable scale inhibitors are preferably a salt, more preferably a calcium or magnesium salt. Suitable scale inhibitors may include a mixture of calcium and magnesium salts, optionally with sodium or ammonium ions. Suitable scale inhibitors are preferably a magnesium salt. For example, said moiety of formula (X) may comprise a counter-ion, to define a salt form, wherein said counter-ion is a calcium or magnesium ion. Said counter-ion is preferably a magnesium ion. Thus, said moiety of formula (X) preferably includes a moiety of the formula [PO₃]M, wherein M represents a calcium or, especially, a magnesium ion.

Suitable scale inhibitors may include phosphate moieties or amino phosphonate moieties of formula [N—(CH₂)n-PO₃]M, where n is an integer in the range 1 to 6, preferably in the range 1 to 4, and M is as described above.

Suitable scale inhibitors may be a salt (for example a calcium or, especially, a magnesium salt) of amino phosphonic acids selected from: aminomethyl phosphonic acid, 1-aminoethyl phosphonic acid, iminodi(methylphosphonic acid), nitrilotri(methyl phosphonic acid)glyphosate, 1-aminopropylphosphonic acid, ethylenediamine tetra(methylene phosphonic acid) [EDTMP], N-(Phosphonomethyl)iminodiacetic acid, (nicotinamidomethyl)phosphonic acid, amino(phenyl)methylphosphonic acid, 1-hydroxyethylidene-1,1-diphosphonic acid (editronic acid or HEDP), diethylenetriamine penta(methylene phosphonic acid) (DTPMP), bis(hexamethylene triamine penta(methylenephosphonic acid)) (BHMP), AEEA phosphonate [Aminoethylethanolamine tri(methylene phosphonate)], 2-(bis(phosphonomethyl)amino)alkane-1-sulfonic acid, N,N-bis(phosphonomethyl)glycine, N,N-bis(phosphonomethyl) metanilic acid, (1-Amino-2-methylpropyl)phosphonic acid.

Examples of phosphates include adenosine monophosphate (AMP), adenosine triphosphate (ATP), C1-10 alkyl phosphates, aryl phosphates, alkylaryl phosphates, 2-aminoethyl dihydrogen phosphate, glycerol phosphate.

Suitable scale inhibitors may be selected from: alkaline earth metal salts of: 1-hydroxyethylidene-1,1-diphosphonic acid (editronic acid or HEDP), adenosine monophosphate (AMP), adenosine triphosphate (ATP), ethylenediamine tetra(methylene phosphonic acid) [EDTMP], diethylenetriamine penta(methylene phosphonic acid) (DTPMP), bis(hexamethylene triamine penta(methylenephosphonic acid)) (BHMP), AEEA phosphonate [Aminoethylethanolamine tri(methylene phosphonate)]; and polymeric scale inhibitors, for example, polyacrylate, polymethacrylate, polyphosphino carboxylic acid salts, salts of maleic anhydride polymers and copolymers, copolymers of allyl sulfonates with acrylates and or maleic acid, acrylate-2-acrylamido-2-methylpropane sulfonic acid copolymers, polyaspartic acid; and including salts, co-polymers and ter-polymers of, or including, any of the aforesaid.

Suitable scale inhibitors may be a calcium or magnesium (especially a magnesium) salt of any of the preceding scale inhibitors.

For example, suitable scale inhibitors may include a moiety of formula (X), may be an acrylate-based polymer, may be a phosphonate-based polymer and/or may include a SOs moiety.

Suitable scale inhibitors may be a calcium or magnesium (especially a magnesium) salt of a phosphonic acid, for example a salt of an amine (e.g. a triamine) phosphonic acid and/or a salt of a triamine pentamethylene phosphonic acid. Specific examples include salt of diethylene triamine pentamethylene phosphonic acids (DETA-based scale inhibitors) and bis-hexamethylene triamine pentamethylene phosphonic acids (BHMP-based scale inhibitors).

Scale inhibitors which include a moiety of formula (X) may be prepared by adding a source of Mg²⁺, for example MgO or MgCl₂, into a solution of a scale inhibitor which includes a moiety of formula (X) until the magnesium salt precipitates. The skilled person will appreciate that commercially available MgO and MgCl₂ may not be pure and may comprise minor amounts of other salts for example calcium salts and, therefore, the scale inhibitor salt produced may contain a minor amount of calcium cations.

A molar ratio of Mg to scale inhibitor may be from 0.1:1 to 10:1, preferably 1:1 to 5:1. Preferably where the source of Mg²⁺ is MgCl₂ and the scale inhibitor is bis-hexamethylene triamine pentamethylene phosphonic acids the molar ratio of MgCl₂:BHMP may be from 3:1 to 5:1.

Suitable scale inhibitors may also be prepared as described in U.S. Pat. No. 7,081,212.

Suitable polymeric scale inhibitors may be selected from sodium polyacrylate, potassium salts of maleic acid copolymers, polyphosphates and copolymers of acrylate and 2-acrylamido-2-methylpropane sulfonic acid and salts thereof.

Preferably, the scale inhibitor (when present) comprises a phosphonate-based scale inhibitor such as aminoethyl ethanolamine tri(methylene phosphonic acid) (commonly referred to as AEEA phosphonate) or a salt thereof.

The additive composition may comprise the one or more scale inhibitors (when present) in any suitable amount. For example, the additive composition may comprise at least 5 wt % of the one or more scale inhibitors, and/or the additive composition may comprise up to 20 wt %, such as up to 15 wt % of the one or more scale inhibitors. The additive composition may, for example, comprise from 5 to 20 wt %, such as from 5 to 15 wt % of the one or more scale inhibitors.

The additive composition may further comprise one or more additional additives independently selected from one or more of a solvent, a surfactant, a winterising agent, a pH adjusting agent, a chelating agent, a binding agent, a demulsifier compound, a preservative, an oxidising agent and a stabiliser (including mixtures thereof). Suitable amounts of such additional additives (when present) would be well known to persons skilled in the art.

Examples of suitable solvents may include water, alcohols (such as isopropyl alcohol), aromatic hydrocarbons (such as benzene, toluene, xylene and a C₁₁-C₁₄ aromatic hydrocarbon), ethers (such as ethylene glycol monobutyl ether) and polyethers (such as polyalkylene glycols) (and mixtures thereof). Suitable amounts of solvent(s) (when present) range from 20 to 80 wt %, such as from 20 to 70 wt % or from 20 to 65 wt %.

Preferably the additive composition comprises water, for example in an amount of from 20 to 80 wt %.

Examples of suitable winterising agents may include methanol. Suitable amounts of winterising agents (when present) range from 1 to 25 wt %.

Examples of suitable stabilisers may include isopropyl alcohol and ethylene glycol monobutyl ether. Suitable amounts of stabilisers (when present) range from 1 to 25 wt %.

Examples of suitable pH adjusting agents may include caustic soda, cyclohexylamine and phosphoric acid. Suitable amounts of pH adjusting agents (when present) range from 0.25 to 2 wt %.

Examples of suitable chelating agents may include iron chelating agents such as citric acid and gluconic acid. Suitable amounts of chelating agents (when present) range from 5 to 30 wt %, such as from 5 to 25 wt %.

Examples of suitable binding agents may include ethylene glycol. Suitable amounts of binding agents (when present) range from 1 to 25 wt %, such as from 1 to 20 wt %

Examples of suitable demulsifier compounds may include resins, polyols (such as propylene glycol), polyol esters, sulfonate, polyglycols (such as polyethylene glycol, polypropylene glycol or polybutylene glycol or block copolymers of polypropylene glycol and polyethylene glycol), for example those sold by Solvay under the Clearbreak name, especially Clearbreak PG 595, polymerised polyols and diepoxide compounds. Suitable amounts of additional demulsifier compounds (when present) range from 1 to 10 wt %.

Examples of suitable surfactants include may anionic surfactants such as alkyl sulfates (for example sodium dodecyl sulfate), alkyl ether sulfates (for example sodium lauryl ether sulfate, ammonium lauryl ether sulfate), alkyl benzene sulfonic acids (for example dodecyl benzene sulfonic acid (DDBSA), diisopropylmethylene sulfonic acid), dialkylbenzene sulfonic acids (for example dinonylnaphthylsulfonic acid), alkyl benzene sulfonates (for example having linear or branched alkyl groups), dialkylbenzene sulfonates, alkyl naphthalene sulfonates, sulfosuccinate esters (for example di(2-ethylhexyl) sulfosuccinate and olefin sulfonates (for example sodium C14-16 olefin sulfonate). Examples of suitable nonionic surfactants include ethoxylated alkylphenol compounds, such as ethoxylated nonylphenol (for example ethoxylated nonylphenol where the nonylphenol is ethoxylated with 9-10 moles of ethylene oxide) and ethoxylated fatty alcohol compounds, such as ethoxylated C12-15 fatty alcohol compounds. Suitable amounts of surfactants (when present) range from 1 to 15 wt %, such as from 1 to 10 wt %.

Examples of suitable oxidising agents may include peracetic acid and hydrogen peroxide. Suitable amounts of oxidising agents (when present) range from 1 to 5 wt %.

The one or more biosurfactants may be added to the aqueous composition to form the aqueous admixture in any suitable manner. For example, the biosurfactants may be added to the aqueous composition as a component of an additive composition (such as an additive composition of the third aspect of the invention). The one or more biosurfactants (or the additive composition) may be mixed and/or dispersed within the aqueous composition to form the aqueous admixture at any point upstream of a pump for dosing the aqueous admixture into a disposal reservoir. For example, the one or more biosurfactants (or the additive composition) may be mixed and/or dispersed within the aqueous composition to form the aqueous admixture in a storage vessel (for example in a storage vessel of an assembly according to the sixth aspect of the invention), or the aqueous admixture may be formed externally and added to the storage receptacle when required for use. Suitably, the one or more biosurfactants (or the additive composition) may be mixed and/or dispersed within the aqueous composition to form the aqueous admixture in a conduit prior to delivery to the disposal reservoir. For example, the aqueous admixture may be formed in such a conduit that is in communication with storage receptacles containing the aqueous composition and one or more biosurfactants (or the additive composition) and with the disposal reservoir.

The method, use, additive composition, aqueous admixture or assembly of the invention may be used with any aqueous composition requiring disposal.

The one or more biosurfactants may be added to the aqueous composition in any suitable amount. For example, the one or more biosurfactants may be admixed with the aqueous composition at a concentration of from 5 to 1000 ppm, such as from 10 to 500 ppm, preferably from 50 to 100 ppm.

The additive composition may be added to the aqueous composition at a concentration of from to 1,000 ppm, preferably from 10 to 500 ppm.

According to a third aspect of the invention, there is provided an additive composition comprising one or more biosurfactants and one or more corrosion inhibitors and/or one or more scale inhibitors.

Features of the additive composition of the third aspect of the invention, for example including of the biosurfactants, the corrosion inhibitors and the scale inhibitors comprised therein, are as set out herein in relation to the method and use of the first and second aspects.

In particular, in the additive composition of the third aspect of the invention, the one or more biosurfactants may be independently selected from a glycolipid, a lipopeptide, a phospholipid and a polymeric biosurfactant (and mixtures thereof). The one or more biosurfactants may be glycolipids, especially sophorolipids.

The additive composition of the third aspect of the invention may comprise the one or more biosurfactants in any suitable amount. For example, the additive composition may comprise at least 5 wt %, such as at least 7 wt % or at least 8 wt %, of the one or more biosurfactants, and/or the additive composition may comprise up to 30 wt %, such as up to 25 wt %, up to 20 wt % or up to 10 wt % of the one or more biosurfactants. The additive composition may, for example, comprise from 5 to 30 wt %, for example from 5 to 25 wt %, or from 5 to 22 wt % or from 5 to 10 wt %, of the one or more biosurfactants.

The additive composition of the third aspect of the invention may comprise the one or more corrosion inhibitors (when present) in any suitable amount. For example, the additive composition may comprise at least 5 wt %, such as at least 10 wt %, of the one or more corrosion inhibitors, and/or the additive composition may comprise up to 30 wt %, such as up to 26 wt % of the one or more corrosion inhibitors. The additive composition may, for example, comprise from to 30 wt %, such as from 10 to 30 wt % of the one or more corrosion inhibitors.

The additive composition of the third aspect of the invention may comprise the one or more scale inhibitors (when present) in any suitable amount. For example, the additive composition may comprise at least 5 wt % of the one or more scale inhibitors, and/or the additive composition may comprise up to 20 wt %, such as up to 15 wt % of the one or more scale inhibitors. The additive composition may, for example, comprise from 5 to 20 wt %, such as from 5 to 15 wt % of the one or more scale inhibitors.

The additive composition of the third aspect of the invention may further comprise one or more additional additives independently selected from one or more of a solvent, a winterising agent, a pH adjusting agent, a chelating agent, a binding agent, a demulsifier compound, a preservative, an oxidising agent and a stabiliser (including mixtures thereof). Suitable amounts of such additional additives (when present) would be well known to persons skilled in the art, for example as disclosed herein. Features of the additional additives (when present) in the additive composition of the third aspect of the invention are as set out herein in relation to the method and use of the first and second aspects.

The invention may further provide a method of improving injectivity of an aqueous composition into a disposal reservoir during a water disposal operation, the method comprising admixing an additive composition according to the third aspect of the invention with the aqueous composition to provide an aqueous admixture and injecting the aqueous admixture into the disposal reservoir.

The invention may further provide the use of an additive composition according to the third aspect of the invention to improve injectivity of an aqueous composition into a disposal reservoir during a water disposal operation.

The additive composition may be made by any suitable method, such as by mixing together the one or more biosurfactants and one or more additional additives in any suitable order.

The invention will now be further described with reference to the following non-limiting examples.

### Example 1

Additive compositions 1 to 4 were each prepared by mixing together the components as shown in Tables 1 to 4 as follows:

TABLE 1
(Additive Composition 1)

| Component | % by weight |
|---|---|
| Water | Balance |
| Ethylene Glycol | 12 |
| Sophorolipid | 5.25 |
| Phosphonate Scale Inhibitor | 10 |
| Alcohol Ethoxylate | 8.75 |
| DDBSA | 1.25 |
| Caustic soda | 0.25 |

TABLE 2
(Additive Composition 2)

| Component | % by weight |
|---|---|
| Water | Balance |
| Ethylene Glycol | 20 |
| Alcohol Ethoxylate | 8.75 |
| Sophorolipid | 5.25 |
| Citric Acid | 20 |
| DDBSA (Soft)* | 2 |
| Nonyl phenol ethoxylated with 9.5 moles ethylene oxide | 5 |
| Polyalkylene Glycol | 5 |

*DDBSA (linear dodecyl group) added as final component when preparing the composition.

TABLE 3
(Additive Composition 3)

| Component | % by weight |
|---|---|
| Water | Balance |
| Ethylene Glycol | 20 |
| Methanol | 4 |
| Quaternary Ammonium Chloride (I) | 10 |
| Phosphonate Scale Inhibitor | 10 |
| Sophorolipid | 5.25 |
| Citric Acid | 10 |
| Gluconic Acid | 5 |

TABLE 4
(Additive Composition 4)

| Component | % by weight |
|---|---|
| Water | Balance |
| Methanol | 15 |
| Isopropyl Alcohol | 5 |
| Citric Acid | 20 |
| Nonyl phenol ethoxylated with 9.5 moles | 5.00 |
| ethylene oxide | |
| Polyalkylene Glycol | 5 |
| Sophorolipid | 5.25 |

Phosphonate Scale Inhibitor is a commercially available AEEA phosphonate (40-60 wt % active)

Polyalkylene glycol is a commercially available composition comprising 95 wt % polyalkylene glycol and 4-5 wt % propylene glycol.

Alcohol ethoxylate is commercially available ethoxylated fatty alcohol, believed to be a C12-15 fatty alcohol ethoxylated with 7 moles ethylene oxide.

Quaternary Ammonium Chloride (I) is a commercially available blend of a blend of 30-60 wt % quaternary fatty imidazoline amines, 15-30 wt % ethoxylated N-tallowalkyltrimethylenediamine

Additive compositions 1 to 4 were compared to Comparatives 1 to 4 (without biosurfactant) as follows.

Comparative 1 is a commercially available blend of hydrogen peroxide and an oxidiser.

TABLE 5
Comparative 2

| Component | % by weight |
|---|---|
| Glycolic Acid | 17 |
| Methanol | 4.5 |
| Polyalkylene Glycol | 5 |
| Phosphoric acid (75 wt % active) | 42 |
| Water | Balance |

TABLE 6
Comparative 3

| Component | % by weight |
|---|---|
| Water | Balance |
| Phosphoric acid (75 wt % active) | 30 |
| Polyalkylene Glycol | 3.5 |
| Methanol | 15 |
| Quaternary Ammonium chloride (II) | 3 |
| Glycolic Acid | 12.5 |

TABLE 7
Comparative 4

| Component | % by weight |
|---|---|
| Water | 43.71 |
| Quaternary Ammonium Chloride (II) | 15 |
| Methanol | 21 |

Quaternary Ammonium Chloride (II) is a commercially available composition comprising: >79 wt % benzenemethanaminium, N-(3-aminopropyl)-N,N-dimethyl-,N-coco acyl derivatives.

Pressurised Millipore tests were conducted to measure the volume (mL) of aqueous composition comprising an additive composition that passed through a 0.45 micron cellulose based membrane in 3 minutes compared to an aqueous composition without an additive composition. A 100 ml sample of aqueous waste fluid was added to a sample bottle that was connected to the membrane and was pulled through using a vacuum pump (with a vacuum of 25 L/min). The test was stopped when either all the fluid had passed through the membrane or the 3 minutes has expired.

An improvement is demonstrated by an increase of fluid pumped within the 3 minute time period (and in some cases a reduction in time taken to for the 100 ml of sample to pass through the filter).

The aqueous compositions tested were obtained from saltwater disposal wells (SWDs) at different locations.

The results are provided in Tables 8 to 10 below.

TABLE 8
Fluid A

| | | Fluid through-put | | |
|---|---|---|---|---|
| Additive Composition | Treat-rate (ppm) | Volume / ml | time | |
| Blank | 0 | 56 | 3 | minutes |
| Additive composition 1 | 100 | 100 | 3 | minutes |
| Comparative 4 | 100 | 49 | 3 | minutes |
| Comparative 1 | 100 | 56.5 | 3 | minutes |
| Comparative 1* | 50 | 100 | 1 | minute |
| Additive composition 1 | 150 | | 36 | seconds |

*50 ppm of Comparative 1 was injected followed by 150 ppm of additive composition 1

TABLE 9
Fluid B

| | | Fluid through-put | | |
|---|---|---|---|---|
| Additive Composition | Treat-rate (ppm) | Volume / ml | time | |
| Blank | 0 | 72.5 | 3 | minutes |
| Additive composition 2 | 100 | 100 | 30 | seconds |

TABLE 10
Fluid C

| | | Fluid through-put | | |
|---|---|---|---|---|
| Additive Composition | Treat-rate (ppm) | Volume / ml | time | |
| Blank | 0 | 33.5 | 3 | minutes |
| Additive composition 3 | 100 | 87 | 3 | minutes |
| Additive composition 4 | 100 | 100 | 35 | seconds |
| Comparative 2 | 100 | 100 | 3 | minutes |
| Comparative 3 | 100 | 70.5 | 3 | minutes |

The present invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of improving injectivity of an aqueous composition into a disposal reservoir during a water disposal operation, the method comprising admixing one or more biosurfactants with the aqueous composition to provide an aqueous admixture and injecting the aqueous admixture into the disposal reservoir.

2. The use of one or more biosurfactants to improve injectivity of an aqueous composition into a disposal reservoir during a water disposal operation.

3. The method of claim 1, wherein the one or more biosurfactants are independently selected from a glycolipid, a lipopeptide, a phospholipid and a polymeric biosurfactant.

4. The method of claim 3, wherein the one or more biosurfactants are glycolipids.

5. The method of claim 4, wherein the one or more biosurfactants are independently selected from a rhamnolipid, a trehalolipid, a sophorolipid and a mannosylerythritol lipid, preferably wherein the one or more biosurfactants are sophorolipids.

6. The method of claim 3, wherein the one or more biosurfactants are lipopeptides, preferably wherein the one or more biosurfactants are independently selected from surfactin and lichenysin.

7. The method of claim 3, wherein the one or more biosurfactants are phospholipids.

8. The method of claim 3, wherein the one or more biosurfactants are polymeric biosurfactants, preferably wherein the one or more biosurfactants are independently selected from liposan, rufisan, emulsan and alasan.

9. The method of claim 1, wherein the one or more biosurfactants are comprised in an additive composition, wherein the additive composition further comprises one or more corrosion inhibitor and/or one or more scale inhibitor.

10. The method of claim 9, wherein the additive composition comprises from 5 to 30 wt % of the one or more biosurfactants.

11. The method of claim 1, wherein the one or more biosurfactants are admixed with the aqueous composition at a concentration of from 50 ppm to 100 ppm.

12. The method of claim 9, wherein the additive composition is added to the aqueous composition at a concentration of from 5 to 1,000 ppm, preferably 10 to 500 ppm.

13. The method of claim 1, wherein injectivity of the aqueous composition is improved by increasing the rate and/or decreasing the pressure at which the aqueous composition (or aqueous admixture) is injected into the disposal reservoir compared to a water disposal operation without the use of one or more biosurfactants.

14. The method of claim 1, wherein the disposal reservoir is a subsurface reservoir, such as a disposal well.

15. The method of claim 1, wherein the aqueous composition comprises flow back water or produced water.

16. An additive composition comprising one or more biosurfactants and one or more corrosion inhibitors and/or one or more scale inhibitors.

17. An aqueous admixture comprising an additive composition according to claim 16 and an aqueous composition.

18. A method of making an aqueous admixture, the method comprising admixing an additive composition according to claim 16 and an aqueous composition.

19. An assembly positioned adjacent to a disposal reservoir, said assembly being arranged to deliver an aqueous composition and an additive composition (for example as an admixture) into the disposal reservoir, said assembly comprising:
(i) a first storage receptacle containing an aqueous composition;
(ii) a second storage receptacle containing an additive composition according to claim 16;
(iii) a conduit for delivering the aqueous composition and the additive composition as an admixture to the disposal reservoir; and
(iv) a pump and optional flow meter for dosing the admixture via said conduit into the disposal reservoir.
